(19) United States
(12) Patent Application Publication
(10) Pub. No.: US 2025/0259997 A1
(43) Pub. Date: Aug. 14, 2025

(54) CATHODE ELECTRODE INCLUDING COBALT-FREE NMX AND LMR CATHODE ACTIVE MATERIALS

(71) Applicant: GM GLOBAL TECHNOLOGY OPERATIONS LLC, Detroit, MI (US)

(72) Inventors: Gongshin QI, Troy, MI (US); Lei Wang, Rochester Hills, MI (US); Devendrasinh Darbar, Sterling Heights, MI (US); Sayed Youssef Sayed Nagy, Troy, MI (US); Meng Jiang, Rochester Hills, MI (US)

(21) Appl. No.: 18/438,877

(22) Filed: Feb. 12, 2024

(51) Int. Cl. H01M 4/36; H01M 4/02; H01M 4/505; H01M 4/525

(52) U.S. Cl. CPC H01M 4/366; H01M 4/505; H01M 4/525; H01M 2004/021; H01M 2004/027; H01M 2004/028

(57) ABSTRACT

A battery cell includes A anode electrodes, C cathode electrodes, wherein each of the C cathode electrodes includes a cathode active material layer arranged on a cathode current collector, and S separators, where A, C, and S are integers greater than one. The cathode active material layer includes cathode active material including LMR cathode active material and NMX cathode active material.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to battery cells including cathode electrodes including cathode active material layers with both NMX and LMR cathode active materials.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer on a cathode current collector. The anode electrodes include an anode active material layer arranged on an anode current collector.

### SUMMARY

A battery cell includes A anode electrodes, C cathode electrodes, wherein each of the C cathode electrodes includes a cathode active material layer arranged on a cathode current collector, and S separators, where A, C, and S are integers greater than one. The cathode active material layer includes cathode active material including LMR cathode active material and NMX cathode active material.

In other features, the cathode active material layer includes the LMR cathode active material, the NMX cathode active material, a conductive additive, and a binder. The cathode active material layer includes a first sublayer arranged on the cathode current collector and including the LMR cathode active material, a first conductive filler, and a first binder. A second sublayer is arranged on the first sublayer and includes the NMX cathode active material, a second conductive filler and a first binder.

In other features, the cathode active material layer includes a plurality of first pillars including the LMR cathode active material arranged on the cathode current collector and a plurality of second pillars including the NMX cathode active material arranged on the cathode current collector. The plurality of first pillars and the plurality of second pillars are arranged in a plurality of rows and a plurality of columns. The plurality of first pillars and the plurality of second pillars alternate in at least one of the plurality of rows and the plurality of columns.

In other features, the NMX cathode active material includes nickel and manganese with a molar ratio in a range from 3/7 to 8/2, and the LMR cathode active material includes nickel and manganese with a molar ratio in a range from 0.2 to 1.0. A weight ratio of the LMR cathode active material to the NMX cathode active material in the cathode active material layer is in a range from 0.5 to 9.0.

In other features, the cathode active material layer includes the LMR cathode active material and the NMX cathode active material in a range from 90 wt % to 98 wt %, a binder in a range from 0.5 wt % to 10 wt %, and a conductive filler in a range from 0.5 wt % to 10 wt %.

In other features, a porosity of the cathode active material layer is in a range from 10% to 40%. An areal capacity of the cathode active material layer is in a range from 1.0 to 10.0 mAh/cm². The A anode electrodes include an anode active material layer including anode active material selected from a group consisting of graphite, Si—C, Si, SiOₓ, lithium metal, and blends thereof.

A method for manufacturing a battery cell includes forming a cathode electrode including a cathode active material layer on a cathode current collector. The cathode active material layer includes cathode active material including LMR cathode active material and NMX cathode active material.

In other features, forming the cathode active material layer includes blending a mixture of the LMR cathode active material, the NMX cathode active material, a conductive additive, and a binder; and one of casting and applying the mixture onto the cathode current collector.

In other features, forming the cathode active material layer includes providing a first mixture of one of the LMR cathode active material and the NMX cathode active material, a first conductive additive, and a first binder; one of casting and applying the first mixture onto the cathode current collector to form a first sublayer; providing a second mixture of the other one of the LMR cathode active material and the NMX cathode active material, a second conductive additive, and a second binder; and one of casting and applying the second mixture on the first sublayer to form a second sublayer.

In other features, forming the cathode active material layer includes depositing a plurality of first pillars including the LMR cathode active material on the cathode current collector, and depositing a plurality of second pillars including the NMX cathode active material on the cathode current collector.

In other features, the plurality of first pillars and the plurality of second pillars are arranged in a plurality of rows and a plurality of columns. The plurality of first pillars and the plurality of second pillars alternate in at least one of the plurality of rows and the plurality of columns.

In other features, the NMX cathode active material includes nickel and manganese with a molar ratio in a range from 3/7 to 8/2, and the LMR cathode active material includes manganese and nickel with a molar ratio in a range from in a range from 0.2 to 1.0. A weight ratio the LMR cathode active material to the NMX cathode active material is in a range from 0.5 to 9.0.

In other features, the cathode active material layer includes the LMR cathode active material and the NMX cathode active material in a range from 90 wt % to 98 wt %, a binder in a range from 0.5 wt % to 10 wt %, and a conductive filler in a range from 0.5 wt % to 10 wt %.

In other features, porosity of the cathode active material layer is in a range from 10% to 40%. An areal capacity of the cathode active material layer is in a range from 1.0 to 10.0 mAh/cm².

In other features, the method includes arranging C of the cathode electrode, A anode electrodes, and S separators in a battery cell stack, where A, C, and S are integers greater than one. The A anode electrodes include an anode active material layer including anode active material selected from a group consisting of graphite, Si, Si—C, SiOₓ, lithium metal, and blend thereof.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a cross section of an example of a battery cell including cathode electrodes, anode electrodes, and separators arranged in an enclosure according to the present disclosure;

FIG. 2A is a side cross section of an example of a cathode electrode including both LMR and NMX cathode active material according to the present disclosure;

FIG. 2B is a side cross section of an example of a cathode electrode including LMR cathode active material that is coated with NMX cathode active material according to the present disclosure;

FIG. 2C is a side cross section of an example of an LMR particle that is coated with NMX cathode active material according to the present disclosure; and

FIGS. 3 to 5C are side cross sections of examples of cathode electrodes including both LMR and NMX cathode active material according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

Cobalt-free, lithium- and manganese-rich (LMR) cathode active materials have high average operating voltages (greater than 3.5 V vs. Li/Li+) and high reversible specific capacities (greater than 200 mAh/g). However, the practical application of LMR cathodes in lithium-ion batteries is challenging. High charging voltage causes electrolyte decomposition and gas formation. Voltage decay occurs due to the structural transformation from the layered phase to spinel phase.

Cobalt-free nickel-manganese cathode active materials (NMX) (e.g., with Mn>50 wt %) have higher cycling stability, lower thermal stability, and a slightly lower specific capacity (160 to 180mAh/g). The present disclosure relates to a cathode electrode including both NMX and LMR cathode active materials to leverage the unique properties of each and to optimize the performance of the battery cell with respect to the operating requirements.

In some examples, the NMX and LMR cathode active materials are mixed and cast or applied onto a cathode current collector using a wet or dry roll-to-roll process, respectively. In some examples, the NMX and LMR cathode active materials are applied as separate layers that are stacked on a cathode current collector using a wet or dry roll-to-roll process. In some examples, the NMX cathode active material is coated onto particles of LMR cathode active material. In some examples, the NMX and LMR cathode active materials form a pattern of alternating pillars (e.g., using 3D printing).

The blended cathode electrode minimizes the degradation of the LMR cathode active material due to gas formation/electrolyte decomposition during cycling. In some examples, the blended cathode electrode is low-cost, cobalt-free, and has higher energy and power density as compared to cathode electrodes using the LMR and NMX cathode active materials individually.

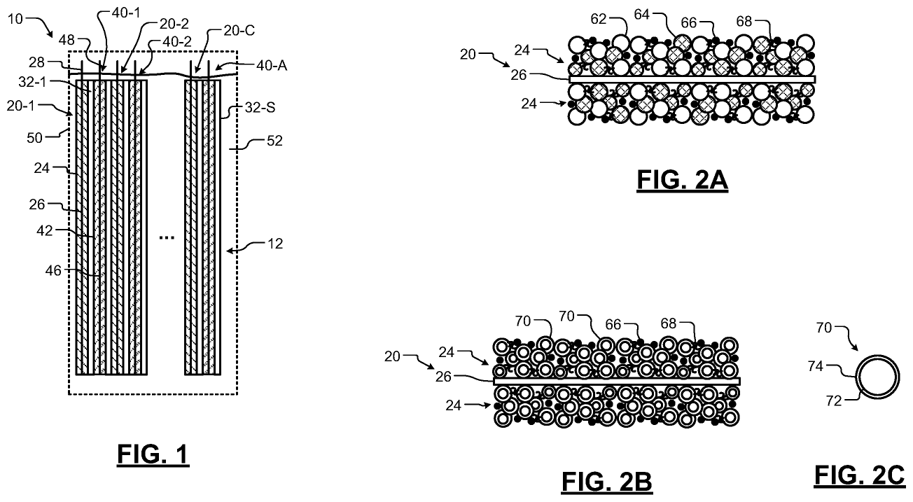

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. In some examples, liquid electrolyte 52 is added to the enclosure 50.

The C cathode electrodes 20-1, 20-2, . . . , and 20-C include a cathode active material layer 24 on one or both sides of a cathode current collector 26. The A anode electrodes 40-1, 40-2, . . . , and 40-A include anode active material layers 42 arranged on one or both sides of the anode current collectors 46. During charging/discharging, the A anode electrodes 40 and the C cathode electrodes 20 exchange lithium ions.

Methods for manufacturing the cathode and/or anode electrodes include wet coating, dry coating, semi-dry coating, and/or 3D printing. In some examples, the cathode active material layers 24 and/or the anode active material layers 42 comprise coatings including one or more active materials, one or more conductive additives, and/or one or more binder materials that are cast or applied to the current collectors using wet or dry roll-to-roll processes.

In some examples, the cathode current collector 26 and/or the anode current collector 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

Referring now to FIG. 2A, one of the C cathode electrodes 20 including a blend of LMR and NMX cathode materials is shown in more detail. The cathode active material layer 24 includes LMR and NMX cathode materials that are physically mixed in a single layer prior to coating or applying onto the cathode current collector using a wet or dry process. The cathode active material layer 24 of the one of the C cathode electrodes 20 includes a first cathode active material 62, a second cathode active material 64, a conductive additive 66, and a binder 68. In some examples, the first cathode active material 62 includes LMR cathode active material and the second cathode active material 64 includes NMX cathode active material.

Referring now to FIGS. 2B and 2C, the cathode active material layer 24 includes coated particles 70 that are mixed with the conductive additive 66 and the binder 68. In FIG. 2C, the coated particles 70 include LMR particles 72 with NMX coatings 74. As can be appreciated, a mixture of NMX coated LMR particles and uncoated LMR particles can be used. In some examples, the LMR particles are coated using one or more methods such as coprecipitation and calcination, mechanical fusion, spray dry coating, etc.

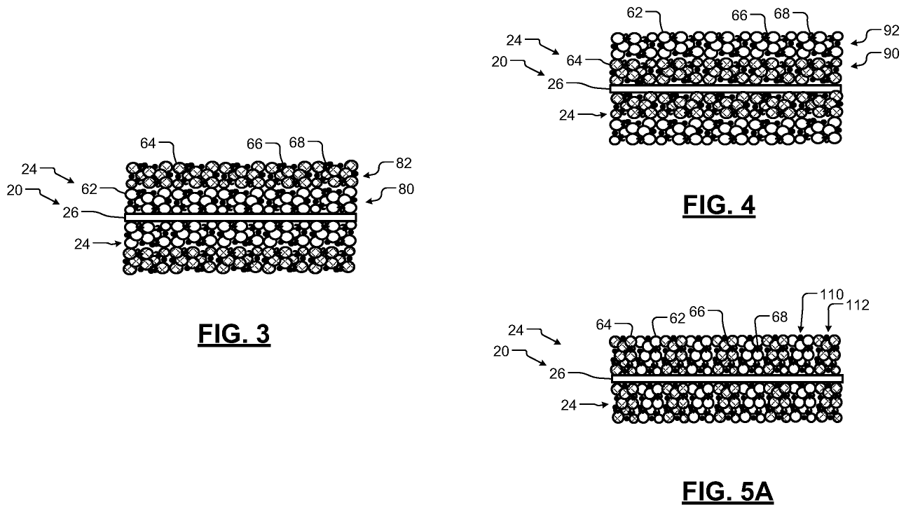

Referring now to FIGS. 3 and 4, one of the C cathode electrodes 20 is shown to include two or more sublayers (e.g., one sublayer including LMR and one sublayer including NMX). In FIG. 3, the cathode active material layer 24 includes a first sublayer 80 and a second sublayer 82. The first sublayer 80 includes LMR cathode active material and is arranged adjacent to (e.g., directly contacting) the cathode current collector 26. The second sublayer 82 includes NMX cathode active material and is arranged adjacent to (e.g., directly contacting) the first sublayer 80. While two sub-layers are shown, additional alternating sublayers can be used.

In FIG. 4, the cathode active material layer 24 includes a first sublayer 90 and a second sublayer 92. The first sublayer 90 includes NMX cathode active material and is arranged adjacent to (e.g., directly contacting) the cathode current collector 26. The second sublayer 92 includes LMR cathode active material and is arranged adjacent to (e.g., directly contacting) the first sublayer 90. While two sub-layers are shown, additional alternating sublayers can be used. In some examples, the sublayers use the same conductive filler and/or a different conductive filler, the same binder and/or different binders. In some examples, the binder includes a fibrillating binder such as PTFE or PVDF.

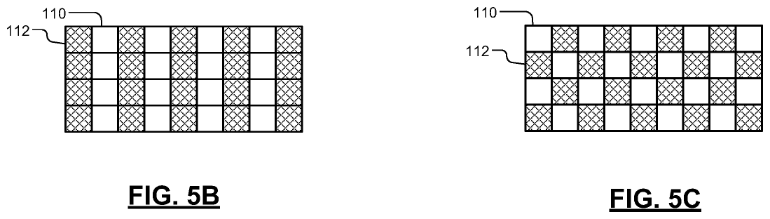

Referring now to FIGS. 5A and 5C, one of the C cathode electrodes 20 is shown to include a pattern of pillars. In FIG. 5A, the cathode active material layer 24 includes a plurality of first pillars 110 and a plurality of second pillars 112. The plurality of first pillars 110 include LMR cathode active material. The ends of the plurality of first pillars 110 are arranged on (e.g., in direct contact with) the cathode current collector 26. The plurality of second pillars 112 are arranged on (e.g., in direct contact with) the cathode current collector 26. In some examples, the plurality of first pillars 110 and the plurality of second pillars 112 alternate in rows and/or columns.

In FIGS. 5B and 5C, the plurality of first pillars 110 and the plurality of second pillars 112 are arranged in rows and columns. In FIG. 5B, the plurality of first pillars 110 or the plurality of second pillars 112 are the same in each column (or row) and alternate in each row (or column). In FIG. 5C, the plurality of first pillars 110 or the plurality of second pillars 112 alternate in each column and row.

In some examples, the LMR cathode active material comprises Li₁₊ₐNi_{b}Mn_{c}M_{d}O, where a+b+c+d=1.0; a is in a range from 0.05 to 0.3; b is in a range from 0.1 to 0.5; c is in a range from 0.2 to 0.8, and d is in a range from 0.01 to 0.2. In some examples, M is a metal selected from a group consisting of cobalt (Co), titanium (Ti), cerium (Ce), iron (Fe), tungsten (W), molybdenum (Mo), vanadium (V), zirconium (Zr), niobium (Nb), tantalum (Ta), aluminum (Al), and magnesium (Mg).

In some examples, the NMX cathode active material comprises LiNiₓMn_{y}M_{z}O₂, where x+y+z=1.0, x is in a range from 0.4 to 0.8; y is in a range from 0.2 to 0.6, and z is in a range from 0.01 to 0.2. M is a metal selected from a group consisting of Fe, W, Mo, V, Zr, Nb, Al, Mg, and Ta.

In some examples, the NMX cathode active material includes both nickel and manganese (Ni/Mn) with a molar ratio in a range from 3/7 to 8/2. In some examples, the NMX cathode active material includes both nickel and manganese (Ni/Mn) with a molar ratio in a range from 4/6 to 8/2. In some examples, the LMR cathode active material includes a Mn/Ni molar ratio in a range from 0.2 to 1.0. In some examples, a lithium to transition metal (Li/TM) molar ratio is in a range from 1.05 to 1.60. In some examples, an LMR/NMX weight ratio is in a range from 0.5 to 9.0.

In some examples, the cathode electrode includes blended cathode active material in a range from 90 wt % to 98 wt %, binder in a range from 0.5 wt % to 10 wt %, conductive filler in a range from 0.5 wt % to 10 wt %. In some examples, cathode electrode porosity is in a range from 10% to 40%. In some examples, the areal capacity of the cathode electrode is in a range from 1.0 to 10.0 mAh/cm².

In some examples, the anode active material includes graphite, Si, silicon-carbide (Si—C) composite, SiOₓ, lithium metal, or blend thereof. In some examples, the battery cell has an N/P ratio in a range from 1 to 3. The N/P ratio is a ratio of the negative electrode capacity to the positive electrode capacity. In some examples, the battery cell uses liquid electrolyte. In other examples, the battery cell uses solid-state electrolyte.

In some examples, single or bimodal particle sizes are used. For example, single-crystal NMX and single-crystal LMR, single-crystal NMX and poly-crystal LMR, poly-crystal NMX and single-crystal LMR, and/or poly-crystal NMX and poly-crystal LMR can be used. In other examples, large particles of LMR and/or NMX are blended with small particles.

In some examples, the battery cell operates in a voltage window in a range from 2.0V to 5.0V. In some examples, the charge and discharge rate (C-rate) of the battery cell is in a range from C/100 to 6C. In some examples, a formation window is in a range from 2.0 V to 5.0V.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A battery cell comprising:
A anode electrodes;
C cathode electrodes, wherein each of the C cathode electrodes includes a cathode active material layer arranged on a cathode current collector; and
S separators, where A, C, and S are integers greater than one,
wherein the cathode active material layer includes cathode active material including LMR cathode active material and NMX cathode active material.

2. The battery cell of claim 1, wherein the cathode active material layer includes the LMR cathode active material, the NMX cathode active material, a conductive additive, and a binder.

3. The battery cell of claim 1, wherein the cathode active material layer includes:
a first sublayer arranged on the cathode current collector and including the LMR cathode active material, a first conductive filler, and a first binder; and
a second sublayer arranged on the first sublayer and including the NMX cathode active material, a second conductive filler and a first binder.

4. The battery cell of claim 1, wherein the cathode active material layer includes:
a plurality of first pillars including the LMR cathode active material arranged on the cathode current collector; and
a plurality of second pillars including the NMX cathode active material arranged on the cathode current collector.

5. The battery cell of claim 4, wherein:
the plurality of first pillars and the plurality of second pillars are arranged in a plurality of rows and a plurality of columns, and
the plurality of first pillars and the plurality of second pillars alternate in at least one of the plurality of rows and the plurality of columns.

6. The battery cell of claim 1, wherein:
the NMX cathode active material includes nickel and manganese with a molar ratio in a range from 3/7 to 8/2, and
the LMR cathode active material includes nickel and manganese with a molar ratio in a range from 0.2 to 1.0.

7. The battery cell of claim 1, wherein a weight ratio of the LMR cathode active material to the NMX cathode active material in the cathode active material layer is in a range from 0.5 to 9.0.

8. The battery cell of claim 1, wherein the cathode active material layer includes:
the LMR cathode active material and the NMX cathode active material in a range from 90 wt % to 98 wt %,
a binder in a range from 0.5 wt % to 10 wt %, and
a conductive filler in a range from 0.5 wt % to 10 wt %.

9. The battery cell of claim 1, wherein:
a porosity of the cathode active material layer is in a range from 10% to 40%; and
an areal capacity of the cathode active material layer is in a range from 1.0 to 10.0 mAh/cm².

10. The battery cell of claim 1, wherein the A anode electrodes include an anode active material layer including anode active material selected from a group consisting of graphite, Si—C, Si, SiOₓ, lithium metal, and blends thereof.

11. A method for manufacturing a battery cell comprising:
forming a cathode electrode including a cathode active material layer on a cathode current collector,
wherein the cathode active material layer includes cathode active material including LMR cathode active material and NMX cathode active material.

12. The method of claim 11, wherein forming the cathode active material layer includes:
blending a mixture of the LMR cathode active material, the NMX cathode active material, a conductive additive, and a binder; and
one of casting and applying the mixture onto the cathode current collector.

13. The method of claim 11, wherein forming the cathode active material layer includes:
providing a first mixture of one of the LMR cathode active material and the NMX cathode active material, a first conductive additive, and a first binder;
one of casting and applying the first mixture onto the cathode current collector to form a first sublayer;
providing a second mixture of the other one of the LMR cathode active material and the NMX cathode active material, a second conductive additive, and a second binder; and
one of casting and applying the second mixture on the first sublayer to form a second sublayer.

14. The method of claim 11, wherein forming the cathode active material layer includes:
depositing a plurality of first pillars including the LMR cathode active material on the cathode current collector; and
depositing a plurality of second pillars including the NMX cathode active material on the cathode current collector.

15. The method of claim 14, wherein:
the plurality of first pillars and the plurality of second pillars are arranged in a plurality of rows and a plurality of columns, and
the plurality of first pillars and the plurality of second pillars alternate in at least one of the plurality of rows and the plurality of columns.

16. The method of claim 11, wherein:
the NMX cathode active material includes nickel and manganese with a molar ratio in a range from 3/7 to 8/2, and
the LMR cathode active material includes manganese and nickel with a molar ratio in a range from in a range from 0.2 to 1.0.

17. The method of claim 11, wherein a weight ratio the LMR cathode active material to the NMX cathode active material is in a range from 0.5 to 9.0.

18. The method of claim 11, wherein the cathode active material layer includes:
the LMR cathode active material and the NMX cathode active material in a range from 90 wt % to 98 wt %,
a binder in a range from 0.5 wt % to 10 wt %,
a conductive filler in a range from 0.5 wt % to 10 wt %.

19. The method of claim 11, wherein:
porosity of the cathode active material layer is in a range from 10% to 40%; and
an areal capacity of the cathode active material layer is in a range from 1.0 to 10.0 mAh/cm².

20. The method of claim 11, further comprising:
arranging C of the cathode electrode, A anode electrodes, and S separators in a battery cell stack, where A, C, and S are integers greater than one,
wherein the A anode electrodes include an anode active material layer including anode active material selected from a group consisting of graphite, Si, Si—C, SiOₓ, lithium metal, and blend thereof.
